(19) United States
(12) Patent Application Publication
(10) Pub. No.: US 2024/0268400 A1
(43) Pub. Date: Aug. 15, 2024

(54) SMOKER FOR EDIBLES

(71) Applicant: Donna Manning Ahrendt, Tomball, TX (US)

(72) Inventor: Donna Manning Ahrendt, Tomball, TX (US)

(21) Appl. No.: 18/168,304

(22) Filed: Feb. 13, 2023

(51) Int. Cl. A23B 4/052

(52) U.S. Cl. CPC A23B 4/052

(57) ABSTRACT

Some implementations may include a smoking apparatus for smoking edible substances. The smoking apparatus may include a base, a smoking chamber coupled with the base, and a receptacle recessed into the base and configured to contain combustible material for production of smoke. The smoking apparatus also may include a fan adjacent contained in the base and configured to move the smoke from the receptacle through a smoke injection port into the smoking chamber.

### TECHNICAL FIELD

The present technology pertains to smoking edibles such as food and drink.

### BACKGROUND

In the culinary arts, adding smoke flavoring may be desirable. However, traditional means for smoking edible substances may be cumbersome. For example, some traditional smoking methods, such as traditional log-fueled fire boxes, produce excess ambient heat and smoke. Therefore, there is a need for a better way to smoke food, drink, and any other suitable substances that people may orally ingest.

### BRIEF DESCRIPTION OF THE DRAWINGS

The drawings are provided to illustrate example implementations of the inventive subject matter and are not to be considered as limiting the scope of the inventive subject matter.

FIG. 1 is a perspective view of an example smoker.

FIG. 2 is a diagrammatic illustration of bottom-side view of an example base.

FIG. 3 is a diagrammatic illustration of a top-side view of an example base.

### DETAILED DESCRIPTION

The description that follows may include example systems, methods, techniques, and program flows that embody embodiments of the disclosure. However, this disclosure may be practiced without these specific details. For clarity, some well-known instruction instances, protocols, structures, and techniques may not be shown in detail.

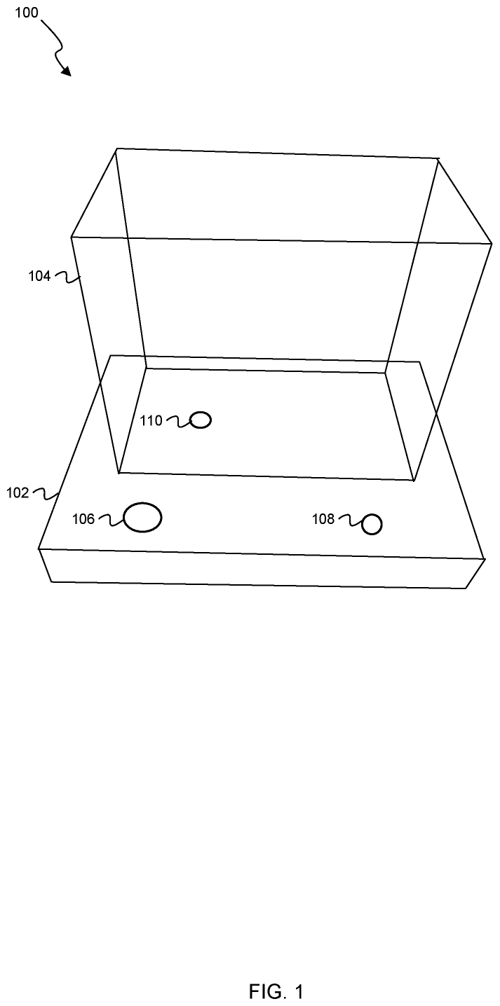

FIG. 1 is a perspective view of an example smoker. In FIG. 1, the smoker 100 may include a base 102 and a smoking chamber 104. The smoking chamber 104 may be any suitable shape (such as cuboid) with an open bottom side, so the inside of the smoking chamber 104 is open to the base 102. The smoking chamber 104 may be constructed of any suitable material, such as acrylic, glass, plastic, wood, etc. Such material may be transparent, translucent, or opaque. A user may place an edible or otherwise human-consumable substance inside the smoking chamber. While inside the smoking chamber the edible or otherwise human consumable substance (e.g., drink, food, etc.) may be exposed to smoke. Exposure to the smoke may cause the edible or otherwise human consumable substance to take-on smoke flavor because smoke particles may contact or be deposited on the substance. For example, a glass with liquid may be placed in the smoking chamber 104. After smoke fills the smoking chamber 104, smoke particles may contact the liquid causing it to take-on a “smoked” flavor.

The base 102 may include a receptacle 106 configured to hold any suitable combustible material (such as wood chips) that may burn to produce smoke used in a process for smoking edible substances. For example, a user may insert wood chips into the receptacle 106 and cause them to burn (such as by exposing them to a flame or other heat source).

A switch 108 may be disposed in the base 102. The switch 108 may be connected to a fan (not shown in FIG. 1), where the fan may draw smoke from the receptacle 106 through a passageway (not shown in FIG. 1) and into the smoking chamber 104. Smoke may enter the smoking chamber 104 through the smoke injection port 110. The smoke injection port 110 may be any suitable passage (e.g., cut-out or void) through the base 102 into the smoking chamber 104. The switch 108 may be any suitable switch, such as a toggle switch, push-button switch, rocker switch, etc.

The base 102 may be any suitable shape and constructed of any suitable material. For example, the base 102 may be cuboid-shaped and constructed from wood. However, the base 102 may be constructed from plastic, acrylic, metal, etc. As described below, the base 102 may be hollow.

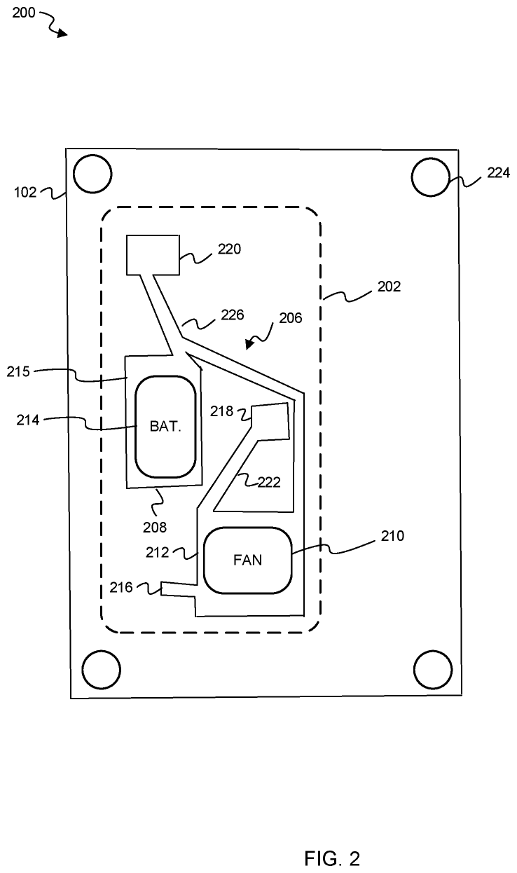

FIG. 2 is a diagrammatic illustration of bottom-side view of an example base. As shown in FIG. 2, the base 102 may include a smoking system 200. The smoking system 200 may include one or more cutouts 206 in which components of the smoking system 200 may be disposed. One or more of the cutouts 206 may be covered by a cover plate 202. The cutouts 206 may include a smoke intake 216 connected to the receptacle 106. The smoke intake 216 may be any suitable passage through which smoke leaves the receptacle 106 moving toward the smoking chamber 104. As a combustible material in the receptacle 106 may burn and produce smoke, a fan 210 may draw the smoke from the receptacle 106 through the smoke intake 216. The fan 210 may push the smoke through a smoke passage 222 and into the smoking chamber 104 through the smoke injection port 110. In some implementations, a tubular or other conduit may route the smoke from the receptacle 106 to the smoking chamber 104.

The cutouts 206 may include wire paths to accommodate wires that may connect the fan 210, battery 214, switch 108, and other components. The wires may pass through the wire passage 220 to connect to the switch 108.

The cutouts 206 may include a battery compartment 215 that contains the battery 214. The battery 214 may be any suitable battery, such as a lithium-ion battery, nickel cadmium battery, etc. Alternatively, any suitable voltage source may be used in place of the battery 214. The battery 214 may be of any suitable voltage capable of powering the fan 210, such as a 9V battery. In some implementations, the battery 214 may include an assembly that includes a plurality of batteries, such as a plurality of AA or AAA batteries, etc.

The cutouts 206 may include a fan compartment 212 containing the fan 210. The fan 210 may be any suitable fan. In some implementations, the fan 210 may operate using a direct current power source, such as the battery 214.

In some implementations, depending on the type and specifications of the battery 214, fan 210, switch 108, etc., the smoking system 200 may include additional electronic components (not shown), such as one or more resistors, diodes, capacitors, etc.

The base 102 also may include contact pads 224 that may soften contact between the base 102 and furniture or other items upon which the smoker 100 may rest. The contact pads 224 may be of any suitable height.

Although the example base 102 shown in FIG. 2 may be constructed from solid material into which the cutouts 206 are made, the base 102 may be hollow. For a hollow base 102, there may be no cutouts 206. Instead, a hollow base 102 may include retaining means (brackets, cubbyholes, etc.) for securing the fan 210, battery 214, and other components. Additionally, a hollow base 102 may include conduits through which the above-described wires may run. A hollow base 102 also may include one or more conduits (e.g., tubulars) through which smoke passes from the smoke intake 216 to the smoke exit 218. After passing through the smoke exit 218, the smoke may pass through the smoke injection port 110 into the smoking chamber 104.

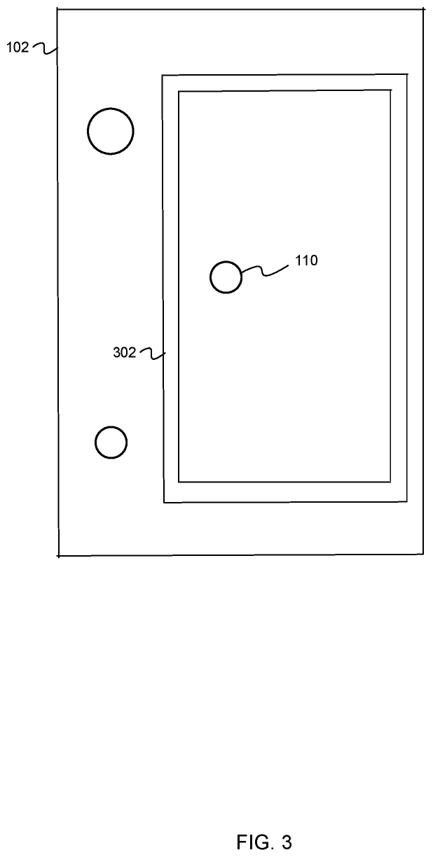

FIG. 3 is a diagrammatic illustration of a top-side view of an example base. As shown in FIG. 3, the base 102 may include a channel 302 in which the smoking chamber sits. In some implementations, the base may not include the channel 302. The interface between the base 102 and smoking chamber 104 may be airtight. In some implementations, the interface between the base 102 and smoking chamber 104 may include a seal (not shown). As described, smoke passes through the smoke injection port 110 into the smoking chamber 104.

In some implementations, components of the smoker 100 may be in different orientations. For example, the orientation shown in FIG. 1 may be inverted where the smoking chamber 104 supports the base 102 (i.e., the smoking chamber 104 is below the base 102. The receptacle 106 may be in any suitable position relative to the other components (inside or outside the smoking chamber 104).

In some implementations, the receptacle 106 is equipped with a spark generator, fuel burning torch, inductive heating element, or other suitable heat source configured to cause combustible material in the receptacle 106 to produce smoke. Upon closing the switch 108, the heat source may temporarily apply heat to the combustible material and then cease application of the heat—while the switch 108 remains closed. In some implementations, the switch 108 may be have multiple positions, where the switch 108 activates the heat source when in a particular position but ceases when in another position. In some implementations, the material may not burn to produce some. For such material, the smoking system 200 may not apply the heat source. The battery 214 may have suitable voltage to power the fan 210 and the spark generator (or other heat source).

Some implementations may include a smoking apparatus for smoking edible substances. The smoking apparatus may include a base, a smoking chamber coupled with the base, and a receptacle recessed into the base and configured to contain combustible material for production of smoke. The smoking apparatus also may include a fan adjacent contained in the base and configured to move the smoke from the receptacle through a smoke injection port into the smoking chamber.

### General Comments

FIGS. 1-3 and the operations described herein are examples meant to aid in understanding example implementations and should not be used to limit the potential implementations or limit the scope of the claims. Some implementations may perform additional operations, fewer operations, operations in parallel or in a different order, and some operations differently.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described throughout. Whether such functionality is implemented in hardware or software depends upon the particular application and design constraints imposed on the overall system.

The hardware and data processing apparatus used to implement the various illustrative logics, logical blocks, modules and circuits described in connection with the implementations disclosed herein may be implemented or performed with a general purpose single- or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor or any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more implementations, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, e.g., one or more modules of computer program instructions stored on a computer storage media for execution by, or to control the operation of, a computing device.

If implemented in software, the functions may be stored on or transmitted over as one or more instructions or code on a computer-readable medium. The processes of a method or algorithm disclosed herein may be implemented in a processor-executable instructions which may reside on a computer-readable medium. Computer-readable media includes both computer storage media and communication media including any medium that may be enabled to transfer a computer program from one place to another. Storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-Ray™ disc where disks usually reproduce data magnetically, while discs reproduce data optically with lasers. Combinations also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, the terms “upper” and “lower” are sometimes used for ease of describing the Figures and indicate relative positions corresponding to the orientation of the Figure on a properly oriented page and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, some operations may be omitted and/or other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described should not be understood as requiring such separation in all implementations, and the described program components and systems may generally be integrated together in a single software product or packaged into multiple software products. Additionally, other implementations are within the scope of the following claims. In some cases, the actions recited in the claims may be performed in a different order and still achieve desirable results.

What is claimed is:

1. A smoking apparatus for smoking edible substances, the smoking apparatus comprising:
a base;
a smoking chamber coupled with the base;
a receptacle recessed into the base and configured to contain combustible material for production of smoke; and
a fan adjacent contained in the base and configured to move the smoke from the receptacle through a smoke injection port into the smoking chamber.

2. The smoking apparatus of claim 1 further comprising:
an fan compartment recessed into a bottom side of the base and configured to contain the fan and;
a tubular coupled with the fan compartment and the smoke injection port, the tubular configured to route the smoke to from the fan compartment to the smoke injection port.

3. The smoking apparatus of claim 2 further comprising:
a battery compartment recessed in the bottom side of the base; and
a battery in the battery compartment and configured to supply power to the fan.

4. The smoking apparatus of claim 3 further comprising:
wiring passageways recessed into the bottom side of the base and configured to provide a path for wiring connected to a switch, the battery, and the fan.

5. The smoking apparatus of claim 1 further comprising:
a switch to activate the fan.

6. A smoking apparatus comprising:
a base including a smoke intake port configured to enable smoke to pass through the base into a smoking chamber on top of the base;
a receptacle recessed in the base and configured to contain combustible material to produce the smoke;
a fan contained in a fan compartment recessed in a bottom side of the base, the fan configured to push the smoke through a first passage spanning from the fan compartment to a second passage through the smoke intake port into the smoking chamber; and
a battery configured to provide power to the fan;
a switch connected to the battery and the fan and configured to cause the battery to provide the power to the fan.

7. The smoking apparatus of claim 6 further including:
a heat source connected to the battery and the switch, the heat source configured to apply heat the combustible material to produce the smoke.

8. The smoking apparatus of claim 6, wherein the heat source is configured to, when the switch is closed, provide heat to the combustible material and then cease provision of the heat.
